(19) United States
(12) Patent Application Publication
(10) Pub. No.: US 2026/0072212 A1
(43) Pub. Date: Mar. 12, 2026

(54) PHOTONIC INTEGRATED CIRCUIT

(71) Applicant: Commissariat à l'Énergie Atomique et aux Énergies Alternatives, Paris (FR)

(72) Inventors: Pierre Chausse, Grenoble (FR); Sylvain Guerber, Grenoble (FR); Sara Congia, Grenoble (FR)

(73) Assignee: Commissariat à l'Énergie Atomique et aux Énergies Alternatives, Paris (FR)

(21) Appl. No.: 19/318,527

(22) Filed: Sep. 4, 2025

(30) Foreign Application Priority Data
Sep. 6, 2024 (FR) 2409501

(51) Int. Cl. G02B 6/122

(52) U.S. Cl. CPC G02B 6/122

(57) ABSTRACT

A photonic integrated circuit including: a semiconductor substrate; an active stack located on the side of a first surface of the semiconductor substrate and including: a first layer made of a first material having a first refractive index coating the first surface of the semiconductor substrate; a second layer made of a second material having a second refractive index coating the first layer; and a third layer made of the first material coating the second layer; at least one photonic component formed in the active stack; and an optically-absorbent layer located vertically in line with said at least one photonic component and in contact with a surface of the first layer opposite to the second layer.

### CROSS REFERENCE TO RELATED APPLICATION

This application claims priority to French application number FR2409501, filed Sep. 6, 2024. The contents of this application is incorporated herein by reference in its entirety.

### TECHNICAL FIELD

The present disclosure generally concerns photonic integrated circuits and, more particularly, quantum photonic integrated circuits, in which the lowest possible optical noise levels are desired to be achieved.

### PRIOR ART

The development of quantum technologies should enable an increase in performance and the introduction of new functionalities as compared with existing communication devices, algorithms, and protocols. Quantum technologies enable, in particular, to secure communications by taking advantage of the no-cloning theorem. Quantum technologies also allow an increase in computing power due to the use of quantum bits, or qubits, instead of conventional bits. In order to make these technologies accessible on a large scale and at low cost, it would be desirable to have photonic integrated circuits in which qubits can be generated, processed, and detected.

Quantum photonic integrated circuits offer a promising path towards the implementation of the above-mentioned technologies. For example, circuits based on silicon or silicon nitride enable, by taking advantage of nonlinear effects of the material, to generate quantum states of a radiation, such as single photon pairs. In practice, a continuous laser radiation from a laser source called “pump” is directed towards a waveguide, inside of which the radiation is strongly confined so that the radiation-matter interaction is sufficiently intense to cause non-linear phenomena. The radiation is more specifically absorbed and, in accordance with the laws of conservation of energy and momentum, a quantum radiation is generated at different wavelengths. Pairs of entangled photons, used as a building block for various quantum photonic applications using qubits, can thus be generated. The photons are then filtered and demultiplexed in order to be directed, according to their wavelength, towards separate waveguides. The use of quantum photonic integrated circuits enables to create and to process quantum states from these photons, which are then analyzed by integrated or remote single-photon detectors, depending on the application.

The fact of working with single photons means that any stray radiation present inside the photonic integrated circuit is likely to adversely affect its performance. The presence of stray radiation limits, in particular, the extinction ratio (ER), that is, a ratio of intensities between the radiation transmitted and blocked by a photonic filter, rejection filters used to remove a laser radiation injected by a source into a photonic integrated circuit. Further, stray radiation causes optical crosstalk, in demultiplexers used to sort photons according to their wavelength. This increases the transfer of unwanted signals into channels of the demultiplexer. The optical noise present in a photonic integrated circuit can further saturate single-photon detectors present in the circuit.

The suppression of stray radiation in photonic integrated circuits is thus a key step in the development of fully integrated technologies exhibiting a high performance.

Several publications have highlighted the presence of stray radiation in photonic circuits. In particular, stray radiation has been detected in photonic circuits in the form of optical background noise present in filters with a high extinction ratio used to suppress an excitation laser radiation originating from a source and to give way to a quantum radiation generated by the circuit.

A photonic circuit enabling to generate and to filter single photon pairs typically comprises a ring-shaped optical resonator, comprising an optical cavity formed by a ring-shaped waveguide enabling to enhance non-linear phenomena which give rise to the generation of pairs of entangled photons, and a filter with a high extinction ratio, generally comprising a plurality of cascaded filtering stages. In theory, an increase in the number of filtering stages should enable to increase the extinction ratio of the filter. However, in practice, the extinction ratio is limited due to phenomena of diffusion of the excitation laser radiation inside the photonic circuit, generating optical background noise which limits the filtering performance.

To attempt overcoming this problem, it has been envisaged to use two separate photonic chips: a first chip intended to receive the laser radiation from the excitation source and to generate pairs of entangled photons, and a second chip intended to process (filtering and demultiplexing) the pairs of photons originating from the first chip. However, this architecture is unsatisfactory since it has the disadvantage of introducing coupling losses at the interface between the first and second photonic chips. In particular, one of the photons of each pair may be lost due to the interface between chips, thus resulting in a degradation of the coincidence count rate by the second chip.

### SUMMARY OF THE INVENTION

There exists a need to overcome all or part of the disadvantages of existing photonic integrated circuits. In particular, it would be desirable to decrease the presence of stray radiation in photonic integrated circuits.

For this purpose, an embodiment provides a photonic integrated circuit comprising:
a semiconductor substrate;
an active stack located on the side of a first surface of the semiconductor substrate and comprising:
   a first layer made of a first material having a first refractive index coating the first surface of the semiconductor substrate;
   a second layer made of a second material having a second refractive index coating the first layer; and
   a third layer made of the first material coating the second layer;
at least one photonic component formed in the active stack; and
at least one optically-absorbent peripheral insulating wall at least partially surrounding said at least one photonic component and extending, from a surface of the third layer opposite to the semiconductor substrate, all the way into the first layer.

According to an embodiment, said at least one peripheral insulating wall extends through the first layer.

According to an embodiment, said at least one peripheral insulating wall penetrates the semiconductor substrate.

According to an embodiment, said at least one peripheral insulating wall:
has, in top view, a C shape; or
comprises two portions, each having, in top view, an L shape.

According to an embodiment, the at least one peripheral insulating wall comprises a trench comprising sides and a bottom coated with a layer made of an optically-absorbent material.

According to an embodiment, said at least one peripheral insulating wall is made of a third material selected from among:
carbon;
germanium;
an absorbent polymer
amorphous silicon;
doped polysilicon;
heavily-doped crystalline silicon;
a material comprising absorbent nanoparticles; and
a metal or a metal alloy.

Further, an embodiment provides a photonic integrated circuit comprising:
a semiconductor substrate;
an active stack located on the side of a first surface of the semiconductor substrate and comprising:
   a first layer made of a first material having a first refractive index coating the first surface of the semiconductor substrate;
   a second layer made of a second material having a second refractive index, coating the first layer; and
   a third layer made of the first material coating the second layer;
at least one photonic component formed in the active stack; and
an optically-absorbent layer located vertically in line with said at least one photonic component and in contact with a surface of the first layer opposite to the second layer.

According to an embodiment, the optically-absorbent layer is made of a third material selected from among:
carbon;
germanium;
an absorbent polymer
amorphous silicon;
doped polysilicon;
heavily-doped crystalline silicon;
a material comprising absorbent nanoparticles; and
a metal or a metal alloy.

According to an embodiment, the circuit further comprises at least one optically-absorbent peripheral insulating wall at least partially surrounding said at least one photonic component and extending from a surface of the third layer opposite the semiconductor substrate all the way into the first layer.

According to an embodiment, said at least one peripheral insulating wall extends through the first layer.

According to an embodiment, the at least one peripheral insulating wall penetrates the semiconductor substrate.

Further, an embodiment provides a photonic integrated circuit comprising:
a semiconductor substrate;
an active stack located on the side of a first surface of the semiconductor substrate and comprising:
   a first layer made of a first material having a first refractive index coating the first surface of the semiconductor substrate;
   a second layer made of a second material having a second refractive index coating the first layer; and
   a third layer made of the first material coating the second layer;
at least one photonic component formed in the active stack; and
at least one peripheral insulating structure comprising an optically-reflective surface at least partially surrounding said at least one photonic component and extending, from a surface of the third layer opposite to the semiconductor substrate, into the active stack.

According to an embodiment, said at least one peripheral insulating structure is filled with air and has, in top view, a side inclined, with respect to a direction of propagation of a radiation in said at least one photonic component, by an angle allowing total reflection of the radiation.

According to an embodiment, said at least one peripheral insulating structure comprises sides coated with a reflective material.

According to an embodiment, the semiconductor substrate is absent under the at least one photonic component.

According to an embodiment, the semiconductor substrate is absent under said at least one peripheral insulating structure.

According to an embodiment, the second refractive index is greater than the first refractive index.

According to an embodiment, the first material is silicon oxide and the second material is silicon.

According to an embodiment, said at least one photonic component is selected from among:
an input surface or an output surface of a waveguide;
a filter;
a resonator;
a demultiplexer; and
a photon detector.

According to an embodiment, the circuit further comprises an optically-absorbent layer located vertically in line with said at least one photonic component and in contact with a surface of the first layer opposite to the second layer.

According to an embodiment, the optically-absorbent layer is located on top of and in contact with the first surface of the semiconductor substrate.

According to an embodiment, the circuit further comprises a cavity extending from a second surface of the semiconductor substrate opposite to the first surface, all the way to the first surface of the semiconductor substrate and located vertically in line with said at least one photonic component, the optically-absorbent layer coating a bottom of the cavity.

### BRIEF DESCRIPTION OF THE DRAWINGS

The foregoing features and advantages, as well as others, will be described in detail in the rest of the disclosure of specific embodiments given as an illustration and not limitation with reference to the accompanying drawings, in which:

FIG. 1A is a top view, simplified and partial, of a photonic integrated circuit according to an embodiment;

FIG. 1B is a side and cross-section view along plane BB of FIG. 1A of the photonic integrated circuit of FIG. 1A;

FIG. 1C is a side and cross-section view along plane BB of FIG. 1A of a variant of the photonic integrated circuit of FIGS. 1A and 1B;

FIG. 2 is a top view, simplified and partial, of a photonic integrated circuit according to an embodiment;

FIG. 3 is a side and cross-section view, simplified and partial, of a photonic integrated circuit according to an embodiment;

FIG. 4 is a side and cross-section view, simplified and partial, of a photonic integrated circuit according to an embodiment;

FIG. 5 is a side and cross-section view, simplified and partial, of a photonic integrated circuit according to an embodiment;

FIG. 6 is a side and cross-section view, simplified and partial, of a photonic integrated circuit according to an embodiment;

FIG. 7A is side and cross-section view, simplified and partial, of a photonic integrated circuit according to an embodiment;

FIG. 7B is a side and cross-section view along plane BB of FIG. 7A of the photonic integrated circuit of FIG. 7A;

FIG. 8 is a top view, simplified and partial, of a photonic integrated circuit according to an embodiment;

FIG. 9 is a top view, simplified and partial, of a photonic integrated circuit according to an embodiment;

FIG. 10 is a perspective view, simplified and partial, of a photonic integrated circuit according to an embodiment;

FIG. 11 is a perspective view, simplified and partial, of a photonic integrated circuit according to an embodiment; and

FIG. 12 is a perspective view, simplified and partial, of a photonic integrated circuit according to an embodiment.

### DESCRIPTION OF EMBODIMENTS

The same elements have been designated by the same references in the various figures. In particular, structural and/or functional elements common to the different embodiments may have the same references and may have identical structural, dimensional and material properties.

For the sake of clarity, only those steps and elements that are useful for understanding the described embodiments have been shown and are described in detail. In particular, the various applications of photonic integrated circuits have not been detailed, the described embodiments being compatible with all or most applications implementing photonic integrated circuits, possibly subject to adaptations within the abilities of those skilled in the art on reading of the present description. Further, the various photonic components of the photonic integrated circuits have not been detailed, the embodiments of the present description being compatible with all or most known photonic components.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, where reference is made to absolute position qualifiers, such as the terms “front”, “back”, “top”, “bottom”, “left”, “right”, etc., or relative position qualifiers, such as the terms “top”, “bottom”, “upper”, “lower”, etc., or orientation qualifiers, such as “horizontal”, “vertical”, etc., reference is made unless otherwise specified to the orientation of the drawings.

Unless specified otherwise, the expressions “about”, “approximately”, “substantially”, and “in the order of”signify plus or minus 10% or 10°, preferably of plus or minus 5% or 5°.

Unless otherwise specified, the expression “in contact with” means “in mechanical contact with.”

In the following description, the qualifiers “insulating” and “conductive” respectively mean, unless otherwise specified, electrically insulating and electrically conductive.

The expression “reflectance of a layer” designates a ratio of the flux of a radiation reflected by the layer to a flux of an incident radiation. Further, the expression “transmittance of a layer” designates a ratio of a flux of a radiation transmitted by the layer to a flux of an incident radiation. In the following description, a layer is said to be absorbent to a radiation when the sum of its reflectance and of its transmittance is, for this radiation, smaller than 50%, preferably smaller than or equal to 25%, more preferably smaller than or equal to 10%. The above definition is not limited to the case of a layer, but more generally applies to any element likely to be exposed to a radiation, for example a wall, a substrate, a region, a stack of a plurality of layers, etc.

In a photonic integrated circuit, stray radiation takes the form of background noise caused by photons escaping photonic components such as high-extinction ratio filters, waveguides associated with these components, etc. The stray radiation is then diffused throughout the entire circuit, part of this radiation being for example collected by an output waveguide.

Stray radiation originates in practice from two types of losses: coupling losses and propagation losses.

Coupling losses correspond to a difference between an input radiation, injected into a photonic component, and an output radiation, transmitted by the photonic component. In the case of a waveguide, part of the input radiation which is not coupled in the waveguide escapes out of the waveguide and is then scattered in the integrated circuit, the circuit generally comprising a stack of layers transparent to the radiation of interest. At each interface, stray radiation is then partially reflected and transmitted, causing a change in its propagation direction. Stray radiation is then scattered throughout the entire circuit along unpredictable propagation paths.

Propagation losses are caused by a radiation initially confined within the waveguide but which manages to escape. The radiation confined within a waveguide propagates according to specific modes, given by Maxwell's equations. The shape of the modes supported by the waveguide, that is, the amplitude of the electromagnetic field in the section of the waveguide, depends on the selected geometry. For a single-mode silicon waveguide of rectangular cross-section, the mode is essentially confined within the waveguide but comprises a portion of the field propagating at the surface of the waveguide. The surface roughness of the waveguide, manufacturing defects at the interface between the core and the sheath, and the radius of curvature of the waveguide tend to cause propagation losses.

Stray radiation, caused by the two above-described loss phenomena, propagates all throughout the photonic integrated circuit.

An object of the described embodiments is to decrease as much as possible the transmission of stray radiation in a photonic integrated circuit. For this purpose, one or more sensitive photonic components of the circuit are isolated from one or more potential sources of stray radiation by absorbing unwanted photons generated by the source(s) and/or by controlling the reflection paths taken by these photons.

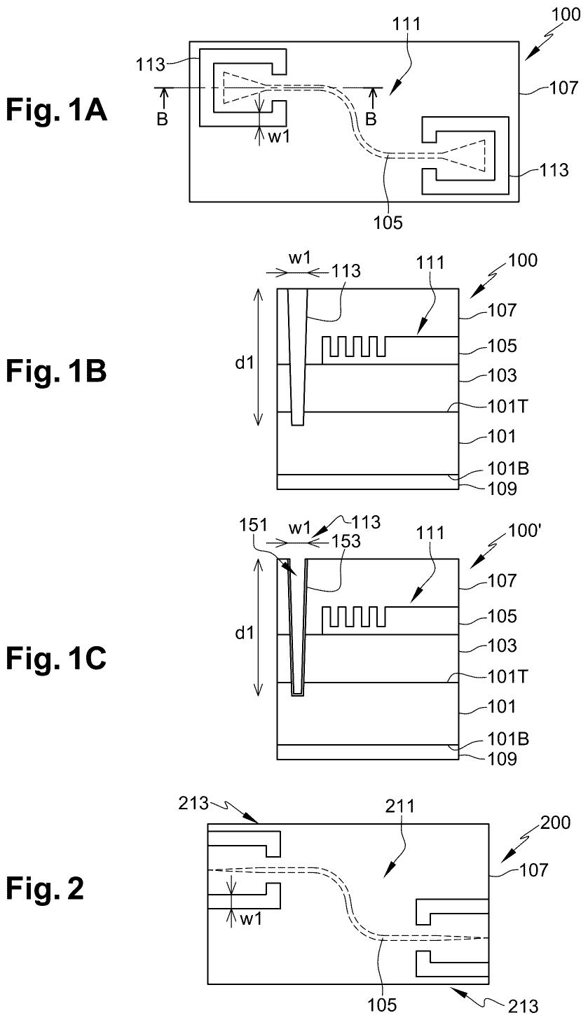

FIG. 1A is a top view, simplified and partial, of a photonic integrated circuit 100 according to an embodiment. FIG. 1B is a side and cross-section view along plane BB of FIG. 1A of the photonic integrated circuit 100 of FIG. 1A.

In the shown example, photonic integrated circuit 100 comprises a semiconductor substrate 101. Semiconductor substrate 101 is, for example, a wafer or a piece of wafer made of a semiconductor material, for example, silicon.

In the shown example, photonic integrated circuit 100 further comprises a layer 103 coating an upper surface 101T of semiconductor substrate 101. In the shown example, layer 103 is more precisely located on top of and in contact, by its lower surface, with the upper surface 101T of semiconductor substrate 101. Layer 103 is made of a material having a refractive index n1. Layer 103 is, for example, an insulating layer, for example made of silicon oxide. As an example, layer 103 has a thickness in the order of a few micrometers, for example in the range from 2 to 3 μm.

In the shown example, photonic integrated circuit 100 further comprises a layer 105 coating a portion of the upper surface of layer 103. In the shown example, layer 105 is more specifically located on top of and in contact, by its lower surface, with a portion of the upper surface of layer 103. Layer 105 is made of a material having a refractive index n2 greater than refractive index n1. Layer 105 is, for example, a semiconductor layer, for example made of silicon, or an insulating layer, for example made of a nitride such as silicon nitride or gallium nitride.

As an example, semiconductor substrate 101 and layers 103 and 105 originate from an SOI (“Silicon On Insulator”) substrate, layer 103 corresponding in this case to a layer of buried oxide (“Buried Oxide”) of the SOI substrate. In this case, layers 103 and 105 are made of silicon oxide and of silicon, respectively.

In the illustrated example, photonic integrated circuit 100 further comprises a layer 107 coating the upper surface and the sides of layer 105. Layer 107 further coats portions of the upper surface of layer 103 not coated by layer 105. In the shown example, layer 107 is more specifically located on top of and in contact, by its lower surface, with the upper surface and the sides of layer 105 and with the portions of the upper surface of layer 103 not coated by layer 105. Layer 107 is, for example, made of the same material as layer 103, that is, the material of refractive index n1. Layer 107 is, for example, an insulating layer, for example made of silicon oxide.

As an example, layers 103, 105, and 107 are part of an active stack located on the side of the upper surface 101T of semiconductor substrate 101.

In the shown example, photonic integrated circuit 100 further comprises a layer 109 coating a lower surface 101B of semiconductor substrate 101. In the shown example, layer 109 is more precisely located under and in contact, by its upper surface, with the lower surface 101B of semiconductor substrate 101. Layer 109 is, for example, an insulating layer, for example made of silicon oxide.

In the shown example, layer 105 is part of a waveguide 111. In this example, layer 105 forms a core of waveguide 111. As an example, waveguide 111 is formed by photolithography and then etching of layer 105, initially coating the entire upper surface of the underlying layer 103. Waveguide 111 comprises, for example, at one of its ends (for example, the left end, in the orientation of FIG. 1A), an input surface intended to receive an excitation signal, for example a laser radiation from a laser source, or pump. The input surface of waveguide 111 is, for example, intended to receive a laser beam under an incidence inclined with respect to the upper surface 101T of semiconductor substrate 101, that is, an incidence non-parallel to surface 101T. Waveguide 111 further comprises, for example, at its other end (the right end in the orientation of FIG. 1A), an output surface intended to transmit a radiation to the outside of photonic integrated circuit 100. The output surface of waveguide 111 is, for example, intended to emit a radiation in a direction inclined with respect to the upper surface 101T of substrate 101. As an example, the input and output surfaces of waveguide 111 enable to perform a so-called “adiabatic”coupling.

The input and output surfaces of waveguide 111 each have, in top view, a generally triangular shape. In the example shown in FIG. 1B, the input surface of waveguide 111 comprises a periodic structure comprising a plurality of trenches of substantially constant width and regularly spaced apart, at a constant pitch. In this example, the trenches of the input surface of waveguide 111 extend in layer 105, from its upper surface, down to a depth smaller than the thickness of layer 105. As an example, the outlet surface of waveguide 111 has a structure similar or identical to that of the input surface.

Waveguide 111 further comprises, for example, a non-straight central portion interposed between its input and output surfaces. In the shown example, the central portion of waveguide 111 has, in top view, an S shape. This example is however not limiting. As a variant, one or more photonic components, for example formed in the active stack comprising layers 103, 105, and 107, may be provided between the input and output surfaces of waveguide 111. For example, the photonic component(s) are selected from among: a resonator, a filter, a demultiplexer, a photon detector, etc.

According to an embodiment, photonic integrated circuit 100 further comprises at least one peripheral insulating wall 113. In the illustrated example, photonic integrated circuit 100 comprises two peripheral insulating walls 113 partially surrounding the input and output surfaces, respectively, of waveguide 111. However, this example is not limiting, and photonic integrated circuit 100 may, as a variant, comprise any number of peripheral insulating walls 113, each wall at least partially surrounding any photonic component, for example different from an input or output surface of a waveguide.

According to an embodiment, each peripheral insulating wall 113 extends from the upper surface of layer 107 all the way into layer 103. In the example illustrated in FIG. 1B, the peripheral insulating wall 113 partially surrounding the input surface of waveguide 111 extends through layer 103 across its entire thickness and extends vertically across the thickness of semiconductor substrate 101. This example is however not limiting. As a variant, peripheral insulating wall 113 may extend through layer 103 and stop on top of and in contact with the upper surface 101T of semiconductor substrate 101, or penetrate across the thickness of layer 103 without extending therethrough. In the shown example, each peripheral insulating wall 113 has a height d1 in the order of one micrometer, for example equal to approximately 5 μm. Each peripheral insulating wall 113 further has a width w1 in the order of a few tens of micrometers, for example equal to approximately 20 μm.

Each peripheral insulating wall 113 may, as illustrated in FIG. 1B, have a flared cross-section, wall 113 being wider at the top, that is, in the vicinity of the upper surface of layer 107, than at the bottom, that is, in the vicinity of the upper surface 101T of semiconductor substrate 101. In this case, the width w1 of peripheral insulating wall 113 corresponds, for example, to the maximum width of wall 113.

Each peripheral insulating wall 113 has, for example, in top view, a C shape surrounding the input surface or the output surface of waveguide 111. However, this example is not limiting, and each peripheral insulating wall 113 may, as a variant, have, in top view, any shape enabling to best surround a photonic component of photonic integrated circuit 100.

Peripheral insulating walls 113 are optically absorbent. For example, peripheral insulating walls 113 more particularly absorb radiation having a wavelength located in a wavelength range of emission of a laser source irradiating waveguide 111.

For example, each peripheral insulating wall 113 is obtained by forming of a trench extending from the upper surface of layer 107 into layer 103 and then deposition, in the trench, of a layer of an optically-absorbent material. In the example illustrated in FIG. 1B, the absorbent material fills the trench previously formed from the upper surface of the structure.

The material of each peripheral insulating wall 113 is for example selected from among:
carbon;
germanium;
an absorbent polymer
amorphous silicon, for example in a case where the wavelength range to be absorbed is around 925 nm;
doped polysilicon, for example in a case where the wavelength range to be absorbed is around 1,550 nm;
heavily-doped crystalline silicon;
a material comprising absorbent nanoparticles that can be surrounded by ligands, for example obtained by evaporation of a solvent contained in a colloidal solution of absorbent nanoparticles; and
a metal or a metal alloy.

An advantage of photonic integrated circuit 100 is that the presence of optically-absorbent peripheral insulating walls 113 surrounding the input and output surfaces of waveguide 111 enables to insulate and protect other photonic components of circuit 100, not shown in FIGS. 1A and 1B. This limits or prevents the propagation of stray radiation in photonic integrated circuit 100, particularly as compared with a circuit similar to circuit 100 but without insulating walls, in which stray radiation can propagate in layer 103, in layer 107, and/or in semiconductor substrate 101 due to the absence of peripheral insulating walls 113.

The peripheral insulating wall 113 surrounding the input surface of waveguide 111 enables to decrease the amount of radiation directly injected into layers 103 and 107 and into semiconductor substrate 101, and that can be guided by these elements to the output surface of waveguide 111. The peripheral insulating wall 113 surrounding the output surface of the waveguide 111 limits the amount of stray radiation escaping through the output of waveguide 111, stray radiation originating from losses in waveguide 111 and/or other photonic components of photonic integrated circuit 100, not shown in FIGS. 1A and 1B.

FIG. 1C is a side and cross-section view along plane BB of FIG. 1A of a variant 100′ of the photonic integrated circuit 100 of FIGS. 1A and 1B. The photonic integrated circuit 100′ of FIG. 1C comprises elements common with the photonic integrated circuit 100 of FIGS. 1A and 1B. These common elements will not be detailed again hereafter.

Photonic integrated circuit 100′ differs from photonic integrated circuit 100 mainly in that, in the case of photonic integrated circuit 100′, each peripheral insulating wall 113 comprises a trench 151 having its sides and its bottom coated with a layer 153 made of optically-absorbent material. In the shown example, trench 151 extends from the upper surface of layer 107, all the way into layer 103. In this example, layer 153 does not fill, that is, does not completely fill, trench 151.

FIG. 2 is a top view, simplified and partial, of a photonic integrated circuit 200 according to an embodiment. The photonic integrated circuit 200 of FIG. 2 comprises elements common with the photonic integrated circuit 100 of FIGS. 1A and 1B. These common elements will not be described in detail hereafter.

Photonic integrated circuit 200 differs from photonic integrated circuit 100 mainly in that it comprises a waveguide 211 having input and output surfaces having, in top view, a tapered shape. Similarly to the waveguide 111 of photonic integrated circuit 100, the waveguide 211 of photonic integrated circuit 200 comprises, for example, a core formed in layer 105.

Unlike waveguide 111, having its input and output surfaces, for example, respectively intended to receive and to transmit a radiation along directions inclined with respect to the upper surface 101T of semiconductor substrate 101, the input and output surfaces of waveguide 211 are, for example, respectively intended to receive and transmit a radiation along directions substantially parallel to the upper surface 101T of semiconductor substrate 101. As an example, the input and output surfaces of waveguide 211 enable to perform a butt coupling.

Similarly to the waveguide 111 of photonic integrated circuit 100, the input and output surfaces of the waveguide 211 of photonic integrated circuit 200 are each surrounded by an optically-absorbent peripheral insulating wall 213. In the example illustrated in FIG. 2, each peripheral insulating wall 213 comprises two portions, each having, in top view, an L shape. The two portions of each peripheral insulating wall 213 are located on either side of a direction of propagation of the radiation within waveguide 211.

Similarly or identically to peripheral insulating walls 113, each of peripheral insulating walls 213 extends from the upper surface of layer 107 to layer 103. Further, each peripheral insulating wall 213 may have a solid structure, for example as previously discussed in relation with FIG. 1B, or a hollow structure comprising an optically-absorbent layer coating the sides and the bottom of a trench, for example as previously discussed in relation with FIG. 1C.

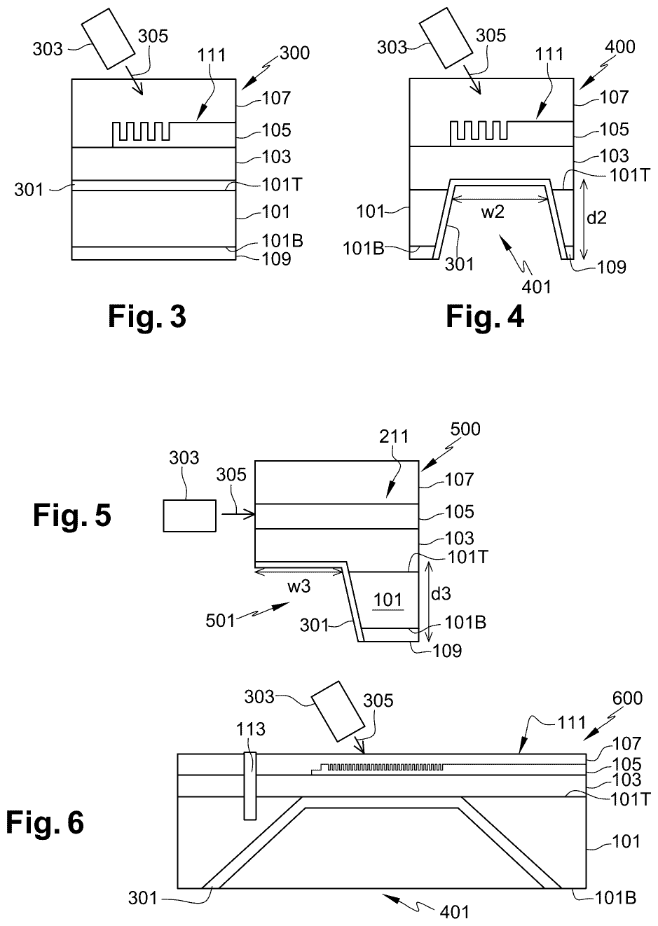

FIG. 3 is a side and cross-section view, simplified and partial, of a photonic integrated circuit 300 according to an embodiment. The photonic integrated circuit 300 of FIG. 3 comprises elements common with the photonic integrated circuit 100 of FIGS. 1A and 1B. These common elements will not be described in detail again hereafter.

According to an embodiment, photonic integrated circuit 300 comprises an optically-absorbent layer 301 located above the input surface of waveguide 111. Optically-absorbent layer 301 is interposed between semiconductor substrate 101 and layer 103. More specifically, in the shown example, optically-absorbent layer 301 is in contact, by its lower surface, with the upper surface 101T of semiconductor substrate 101. Further, in this example, optically-absorbent layer 301 is in contact, by its upper surface, with the lower surface of layer 103.

As an example, optically-absorbent layer 301 is made of a material selected from among:
carbon;
germanium;
an absorbent polymer
amorphous silicon, for example in a case where the wavelength range to be absorbed is around 925 nm;
doped polysilicon, for example in a case where the wavelength range to be absorbed is around 1,550 nm;
heavily-doped crystalline silicon;
a material comprising absorbent nanoparticles that can be surrounded by ligands, for example obtained by evaporation of a solvent contained in a colloidal solution of absorbent nanoparticles; and
a metal or a metal alloy.

Optically-absorbent layer 301 coats, for example, the entire upper surface 101T of semiconductor substrate 101. As an example, optically-absorbent layer 301 is deposited over the entire surface 101T of substrate 101 prior to the deposition of layers 103, 105, and 107.

In the shown example, a source of laser radiation 303, symbolized by a rectangle in FIG. 3, emits a laser radiation 305 toward the input surface of waveguide 111. In the shown example, laser radiation 305 is emitted by source 303 along a direction inclined with respect to the upper surface 101T of semiconductor substrate 101.

In the shown example, photonic integrated circuit 300, is, as compared with the photonic integrated circuit 100 of FIGS. 1A and 1B, deprived of peripheral insulating walls 113. However, this example is not limiting, and photonic integrated circuit 300 may, as a variant, comprise peripheral insulating walls similar or identical to peripheral insulating walls 113.

An advantage of photonic integrated circuit 300 is that the presence of optically-absorbent layer 301 vertically in line with the input surface of waveguide 111 limits or prevents the propagation of stray radiation in the structure of photonic integrated circuit 300, in particular in semiconductor substrate 101 and in layer 103.

FIG. 4 is a side and cross-section view, simplified and partial, of a photonic integrated circuit 400 according to an embodiment. The photonic integrated circuit 400 of FIG. 4 comprises elements common with the photonic integrated circuit 300 of FIG. 3. These common elements will not be described in detail again hereafter.

Photonic integrated circuit 400 differs from photonic integrated circuit 300 in that, in the case of circuit 400, the optically-absorbent layer 301 located under and in contact with layer 103 coats sides and a bottom of a cavity 401, or trench, extending from the lower surface of layer 109 to layer 103. In the shown example, cavity 401 extends through semiconductor substrate 101 and stops across the thickness of layer 103. This example is however not limiting, and cavity 401 may, as a variant, not penetrate layer 103.

Cavity 401 has, for example, in top view, a substantially rectangular shape. This example is however not limiting, and cavity 401 may more generally have, in top view, any shape, for example a polygonal shape other than rectangular—for example square, triangular, hexagonal, etc.—or a rounded shape—for example oval, circular, etc.

Cavity 401 has, for example, a depth d2. As an example, the depth d2 of cavity 401 is in the order of several hundred micrometers, for example equal to approximately 700 μm.

Further, cavity 401 has a minimum lateral dimension w2. Cavity 401 may, as illustrated in FIG. 4, have a flared cross-section, cavity 401 being wider at the bottom, that is, in the vicinity of the lower surface 101B of semiconductor substrate 101, than at the top, that is, in the vicinity of the upper surface 101T of semiconductor substrate 101. In this case, the dimension w2 of cavity 401 corresponds, for example, to the width of the bottom of cavity 401. As an example, the dimension w2 of cavity 401 is in the order of several tens of or of some hundred micrometers, for example equal to approximately 100 μm.

FIG. 5 is a side and cross-section view, simplified and partial, of a photonic integrated circuit 500 according to an embodiment. The photonic integrated circuit 500 of FIG. 5 comprises elements common with the photonic integrated circuit 300 of FIG. 3. These common elements will not be described in detail again hereafter.

Photonic integrated circuit 400 differs from photonic integrated circuit 300 in that it comprises, instead of waveguide 111, waveguide 211.

In the shown example, laser radiation source 303 emits laser radiation 305 toward the input surface of waveguide 211. In the shown example, laser radiation 305 is emitted by source 303 along a direction substantially parallel to the upper surface 101T of semiconductor substrate 101.

Photonic integrated circuit 500 comprises, under the input surface of waveguide 211, a cavity 501 having its walls coated with optically-absorbent layer 301. Cavity 501 is, for example, similar to cavity 401. Unlike cavity 401, laterally bordered on all sides by semiconductor substrate 101, cavity 501 comprises at least one side emerging onto a lateral surface of the structure of photonic integrated circuit 500.

In the shown example, cavity 501 has a depth d3 and a minimum lateral dimension w3. The depth d3 and the dimension w3 of cavity 501 have, for example, respectively values identical to those indicated hereabove for depth d2 and to the minimum lateral dimension w2 of cavity 401.

FIG. 6 is a side and cross-section view, simplified and partial, of a photonic integrated circuit 600 according to an embodiment. The photonic integrated circuit 600 of FIG. 6 comprises elements common with the photonic integrated circuit 400 of FIG. 4. These common elements will not be described in detail hereafter.

Photonic integrated circuit 600 differs from photonic integrated circuit 400 in that it further comprises optically-absorbent peripheral insulating wall 113 surrounding the input surface of waveguide 111.

An advantage of photonic integrated circuit 600 lies in the fact that it enables, as compared with photonic integrated circuits 100 and 300, to further limit the propagation of stray radiation in the structure.

Although layer 109 has not been shown in FIG. 6, photonic integrated circuit 600 may of course comprise layer 109 on the side of the lower surface 101B of semiconductor substrate 101.

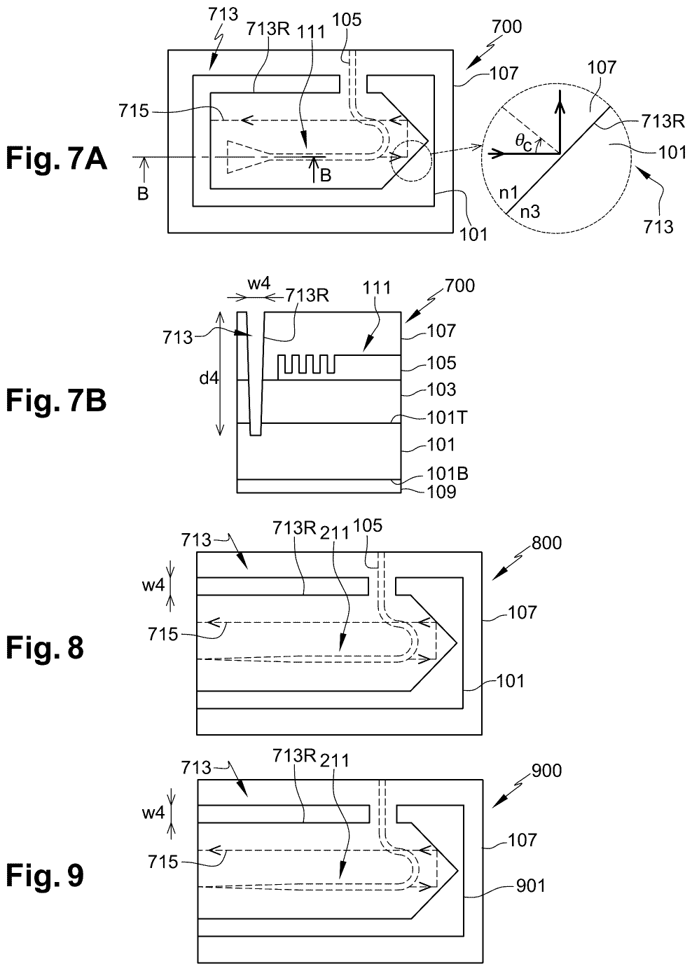

FIG. 7A is a top view, simplified and partial, of a photonic integrated circuit 700 according to an embodiment. FIG. 7B is a side and cross-section view along plane BB of FIG. 7A of the photonic integrated circuit 700 of FIG. 7A. The photonic integrated circuit 700 of FIGS. 7A and 7B comprises elements common with the photonic integrated circuit 100 of FIGS. 1A and 1B. These common elements will not be described in detail again hereafter.

Photonic integrated circuit 700 differs from photonic integrated circuit 100 mainly in that it lacks peripheral insulating walls 113 and in that it comprises a peripheral isolation structure 713 having an optically-reflective surface 713R surrounding the input surface of waveguide 111.

In the shown example, peripheral insulating structure 713 takes advantage of the phenomenon of total internal reflection (TIR).

According to an embodiment, peripheral insulating structure 713 at least partially surrounds a photonic component and extends from the upper surface of layer 107 into the active stack comprising layers 103, 105, and 107. In the shown example, peripheral insulating structure 713 partially surrounds the input surface of waveguide 111. Further, in this example, peripheral insulating structure 713 extends from the upper surface of layer 107 through layers 107, 105, and 103 and stops across the thickness of semiconductor substrate 101. This example is however not limiting. As a variant, peripheral insulating structure 713 may extend through layer 103 and stop on top of and in contact with the upper surface 101T of semiconductor substrate 101, or penetrate the thickness of the layer 103 without extending therethrough.

In the shown example, peripheral insulating structure 713 has a height d4 in the order of several hundred micrometers, for example equal to approximately 100 μm. Peripheral insulating structure 713 further has a width w4 in the order of a few tens of micrometers, for example equal to approximately 20 μm.

Peripheral insulating structure 713 may, as illustrated in FIG. 7B, have a flared cross-section, structure 713 being wider at the top, that is, in the vicinity of the upper surface of layer 107, than at the bottom, that is, in the vicinity of the upper surface 101T of semiconductor substrate 101. In this case, the width w4 of peripheral insulating structure 713 corresponds, for example, to the maximum width of peripheral insulating structure 713.

In the shown example, peripheral insulating structure 713 has the form of an air-filled trench. In this example, optically-reflective surface 713R comprises a surface having its normal inclined by an angle θc, called critical angle, with respect to the direction of propagation of the radiation inside waveguide 111 from the input surface of waveguide 111. This enables to ascertain that stray radiation escaping out of waveguide 111 and reaching optically-reflective surface 713R is totally reflected in the portion of the active structure bordered by peripheral insulating structure 713 and does not propagate outside peripheral insulating structure 713. In FIG. 7A, dotted lines symbolize a path of propagation 715 of stray radiation within an area laterally delimited by the optically-reflective surface 713R of peripheral insulating structure 713.

In the shown example, the reflected stray radiation reaches another surface of optically-reflective surface 713R. Similarly to what has been previously described, said surface is inclined so that the stray radiation undergoes total reflection and is accordingly confined within peripheral insulating structure 713.

The critical angle θc enabling to obtain a total reflection of the stray radiation depends on the refractive index n1 of the material of layer 107 and on a refractive index n3 of the material located inside peripheral insulating structure 713—in the case in point, air. Critical angle θc is more precisely equal to arcsin(n3/n1). In the case where layer 107 is made of silicon oxide and peripheral insulating structure 713 is filled with air, critical angle θc is approximately 43.6°.

An advantage of photonic integrated circuit 700 lies in the fact that it enables to confine, within peripheral insulating structure 713, the stray radiation generated by waveguide 111. This enables to isolate waveguide 111 and to protect, from stray radiation, other photonic components of circuit 700, not detailed in FIGS. 7A and 7B. This limits or prevents the propagation of stray radiation in photonic integrated circuit 700, particularly as compared with a circuit similar to circuit 700 but lacking peripheral insulating structure 713, in which stray radiation can propagate in layer 103, in layer 107, and/or in semiconductor substrate 101 due to the absence of peripheral insulating structure 713.

FIG. 8 is a top view, simplified and partial, of a photonic integrated circuit 800 according to an embodiment. The photonic integrated circuit 800 of FIG. 8 comprises elements common with the photonic integrated circuit 700 of FIGS. 7A and 7B. These common elements will not be described in detail again hereafter.

Photonic integrated circuit 800 differs from photonic integrated circuit 700 mainly in that it comprises, instead of waveguide 111, waveguide 211. In the shown example, peripheral insulating structure 713 emerges on the side of a lateral surface of photonic integrated circuit 800 with which the input surface of waveguide 211 is flush.

Photonic integrated circuit 800 has advantages similar or identical to those of photonic integrated circuit 700.

FIG. 9 is a top view, simplified and partial, of a photonic integrated circuit 900 according to an embodiment. The photonic integrated circuit 900 of FIG. 9 comprises elements common with the photonic integrated circuit 800 of FIG. 8. These common elements will not be described in detail again hereafter.

Photonic integrated circuit 900 differs from photonic integrated circuit 800 mainly in that its peripheral insulating structure 713 is at least partially filled with a reflective material 901, causing a reflection of stray radiation generated by waveguide 211, enabling to confine this radiation inside peripheral insulating structure 713.

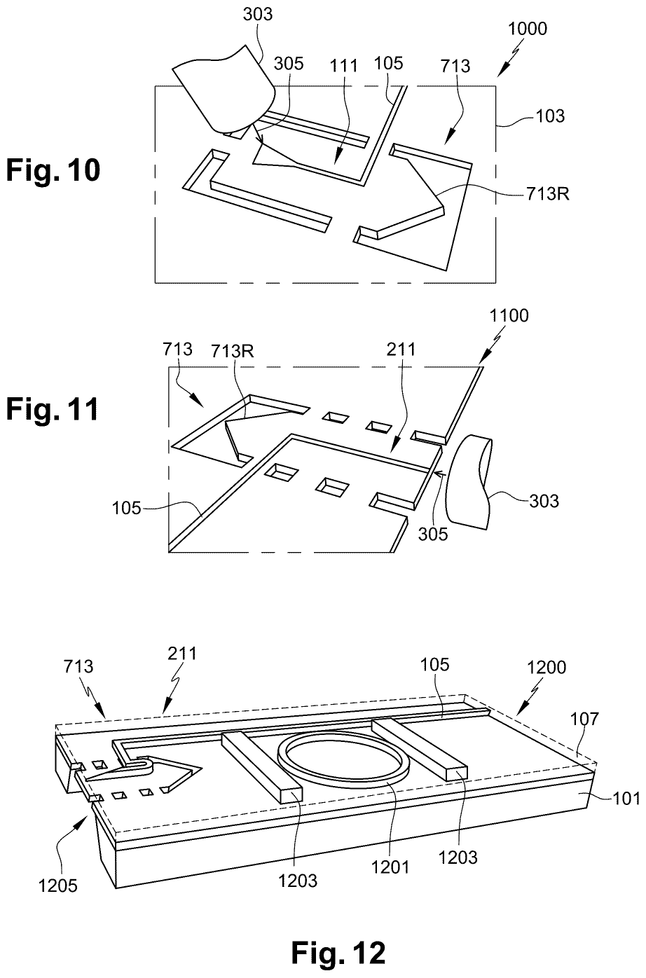

FIG. 10 is a perspective view, simplified and partial, of a photonic integrated circuit 1000 according to an embodiment. The photonic integrated circuit 1000 of FIG. 10 comprises elements common with the photonic integrated circuit 700 of FIGS. 7A and 7B. These common elements will not be detailed again hereafter. For the clarity of the drawing, layer 107 has not been shown in FIG. 10.

Photonic integrated circuit 1000 differs from photonic integrated circuit 700 mainly in that integrated circuit 1000 lacks semiconductor substrate 101 under peripheral insulating structure 713 and under the input surface of waveguide 111.

This enables, as compared with photonic integrated circuit 700, to further limit or prevent the propagation of stray radiation. This enables in particular to limit or prevent the propagation, within semiconductor substrate 101, of stray radiation generated in the vicinity of the input surface of waveguide 111.

FIG. 11 is a perspective view, simplified and partial, of a photonic integrated circuit 1100 according to an embodiment. The photonic integrated circuit 1100 of FIG. 11 comprises elements common with the photonic integrated circuit 800 of FIG. 8. These common elements will not be described in detail hereafter. For the sake of clarity, layer 107 has not been shown in FIG. 11.

Photonic integrated circuit 1100 differs from photonic integrated circuit 800 mainly in that integrated circuit 1100 lacks semiconductor substrate 101 under peripheral insulating structure 713 and under the input surface of waveguide 211.

This enables, as compared with photonic integrated circuit 800, to further limit or prevent the propagation of stray radiation. This enables, in particular, to limit or prevent the propagation, inside semiconductor substrate 101, of stray radiation generated in the vicinity of the input surface of waveguide 211.

FIG. 12 is a perspective view, simplified and partial, of a photonic integrated circuit 1200 according to an embodiment.

In the shown example, photonic integrated circuit 1200 comprises waveguide 211, peripheral insulating structure 713 surrounding the input surface of waveguide 211, and a resonator 1201. Resonator 1201 is located near a straight portion of waveguide 211 and has, in top view, a ring shape. Resonator 1201 comprises, for example, a ring-shaped region formed in layer 105.

In the shown example, peripheral insulating walls 1203 are arranged on either side of resonator 1201. In this example, peripheral insulating walls 1203 each have a straight shape extending laterally along a main direction substantially orthogonal to the direction of propagation of the radiation inside the straight portion of waveguide 211. Peripheral insulating walls 1203 each have, for example, a structure similar to that of the peripheral insulating walls 113 of the photonic integrated circuit 100 of FIGS. 1A and 1B.

In the shown example, photonic integrated circuit 1200 comprises a cavity 1205 located in semiconductor substrate 101, vertically in line with the input surface of waveguide 211 and peripheral insulating structure 713. In this example, cavity 1205 extends vertically across the entire thickness of semiconductor substrate 101, so that semiconductor substrate 101 is absent under the input surface of waveguide 211 and under peripheral insulating structure 713.

An advantage of photonic integrated circuit 1200 is that the absence of semiconductor substrate 101 under the input surface of waveguide 211 and under peripheral insulating structure 713 enables to limit or prevent the propagation, particularly in semiconductor substrate 101, of stray radiation generated in the vicinity of the input surface of waveguide 211. Further, the presence of peripheral insulating walls 1203 around resonator 1201 enables to limit or prevent the propagation, in particular in layers 103 and 107, of stray radiation generated by resonator 1201.

Various embodiments and variants have been described. Those skilled in the art will understand that certain features of these various embodiments and variants may be combined, and other variants will occur to those skilled in the art. In particular, those skilled in the art are capable, based on the information of the present description, of providing a photonic integrated circuit comprising optically-absorbent layer 301, located vertically in line with at least one photonic component and in contact with a surface of layer 103 opposite to layer 105, and at least one peripheral insulating wall 113 or a peripheral insulating structure 713 surrounding the component.

Further, what is more particularly discussed in relation with an example of application to quantum photonic integrated circuits more generally applies to any type of photonic integrated circuit.

Finally, the practical implementation of the described embodiments and variants is within the abilities of those skilled in the art based on the functional indications given hereabove. In particular, the described embodiments are not limited to the specific examples of materials and dimensions mentioned in the present disclosure.

1. Photonic integrated circuit comprising:
a semiconductor substrate;
an active stack located on the side of a first surface of the semiconductor substrate and comprising:
a first layer made of a first material having a first refractive index coating the first surface of the semiconductor substrate;
a second layer made of a second material having a second refractive index coating the first layer; and
a third layer made of the first material coating the second layer;
at least one photonic component formed in the active stack; and
an optically-absorbent layer located vertically in line with said at least one photonic component and in contact with a surface of the first layer opposite to the second layer, the circuit further comprising a cavity extending, from a second surface of the semiconductor substrate opposite to the first surface, all the way to the first surface of the semiconductor substrate and located vertically in line with said at least one photonic component, the optically-absorbent layer coating a bottom of the cavity.

2. Circuit according to claim 1, wherein the optically-absorbent layer is located on top of and in contact with the first surface of the semiconductor substrate.

3. Circuit according to claim 1, wherein the optically-absorbent layer is made of a third material selected from among:
carbon;
germanium;
an absorbent polymer
amorphous silicon;
doped polysilicon;
heavily-doped crystalline silicon;
a material comprising absorbent nanoparticles; and
a metal or a metal alloy.

4. Circuit according to claim 1, wherein the second refractive index is greater than the first refractive index.

5. Circuit according to claim 4, wherein the first material is silicon oxide and the second material is silicon.

6. Circuit according to claim 1, wherein said at least one photonic component is selected from among:
an input surface or an output surface of a waveguide;
a filter;
a resonator;
a demultiplexer; and
a photon detector.

7. Circuit according to claim 1, further comprising at least one optically-absorbent peripheral insulating wall at least partially surrounding said at least one photonic component and extending, from a surface of the third layer opposite to the semiconductor substrate, all the way into the first layer.

8. Circuit according to claim 7, wherein said at least one peripheral insulating wall extends across the first layer.

9. Circuit according to claim 8, wherein said at least one peripheral insulating wall penetrates the semiconductor substrate.
